(19) United States
(12) Patent Application Publication
(10) Pub. No.: US 2004/0031233 A1
(43) Pub. Date: Feb. 19, 2004

(54) Qwik pin

(76) Inventors: Timothy Wayne Cope, New Orleans, LA (US); Troy Michael Koehlar, New Orleans, LA (US)

Correspondence Address: JOHN KARL ETTER, RODNEY LAW FIRM, SUITE 3311, 201 ST. CHARLES AVENUE, NEW ORLEANS, LA, 70170, US

(21) Appl. No.: 10/641,278

(22) Filed: Aug. 14, 2003

Related U.S. Application Data
(60) Provisional application No. 60/403,968, filed on Aug. 16, 2002.

(51) Int. Cl. E06B 7/08; E04B 1/61

(52) U.S. Cl. 52/769; 52/473; 49/74.1

(57) ABSTRACT

A Qwik Pin is disclosed which allows repair of broken louvers of traditional fixed and movable louver shutters without requiring disassembly of the entire shutter. Housings with spring-loaded pins are installed into both sides of the shutter frame either in drilled holes or in the existing grooves that held the broken louver. By depressing the spring-loaded pins a new louver can be installed and is then secured by the pins protruding into holes in the ends of the louver. The louver can be fixed using a two-pin configuration of the invention or can be movable using the single pin configuration. This provides for quick replacement of broken louvers at the home or job site without disassembly, ungluing or using jigs to reassemble the shutter.

### FIELD OF INVENTION

The present invention pertains to an apparatus to repair broken louvers of louvered shutters without disassembling the shutter. More particularly, this invention pertains to a spring-loaded pin apparatus to facilitate replacement of individual shutter louvers.

### BACKGROUND OF INVENTION

Shutters with louvers have been known and used for many years and have been manufactured of a variety of materials including wood, metal and plastics. Shutters can either have fixed or movable louvers. Shutters with fixed louvers typically have a rectangular frame with louvers mounted in grooves or slots in the sides of the frame. Fixed louvers are typically longer than the inner width of the frame, so that the ends of the louvers can be held in the grooves or slots in the frame. A fixed louver shutter is assembled by simultaneously inserting all of the louvers into the sides of the frame while also connecting the top and bottom frame members to the sides of the frame. Movable louver shutters also include a top frame, a bottom frame and a plurality of louvers. Being able to rotate the louvers allows adjusting the shutter to allow more or less light or air to pass between the louvers. Typically, pins or dowels are placed into the ends of each louver and into holes in the side frame. A traditional movable louver shutter is similarly assembled by simultaneously inserting the dowels or pins for all of the louvers into the holes in the sides of the frame while connecting the top and bottom to the sides. Some movable louver shutters use brackets, rails or adapters to hold the louvers which can simplify assembly and louver replacement, and for which the present invention would not be applicable.

Individual louvers frequently break, due to aging, weather, or objects striking the louvers. Replacing one or more louvers in a traditionally-constructed shutter requires disassembling the shutter frame, replacing the damaged louver, and reassembling all of the louvers with the top, bottom and sides of the frame. This usually requires ungluing or otherwise disassembling the entire shutter, and using, jigs or other equipment to align all of the louvers to simultaneously reassemble the many components. Due to this complexity, replacing one or more damaged louvers is time-consuming, expensive and beyond the skills of the average homeowner, and cannot usually be accomplished at the building site.

### DESCRIPTION OF RELATED ART

Louvered shutters are well-known. Traditional fixed louver shutters use louvers that are longer than the width of the shutter frame, such that the ends of the louvers can be secured by grooves or slots in the side frames of the shutter. The use of dowels or tenons to hold the louvers was disclosed by Rolfe, U.S. Pat. No. 229,226. Shutters with movable louvers are also well-known, and have typically been made by using dowels or pins at the ends of the louvers to attach the louvers to the sides of the frame while allowing rotation of the louvers. See e.g. Fletcher, U.S. Pat. No. 165,812; Wogan, U.S. Pat. No. 1,582,111. A movable shutter design using adapters to secure and allow pivoting of the louvers was disclosed by Economou, U.S. Pat. No. 3,691,687. A moveable louver shutter assembly using compression springs and pins mounted in the side frame members was disclosed by Alexanian, U.S. Pat. No. 5,887,386. The use of compression springs and pins mounted within the ends of movable louvers in a shutter assembly was described by Underdahl, U.S. Pat. No. 5,339,591. Underdahl discloses that a louver of a shutter constructed with spring loaded mounting pins and holes in the shutter frame to accommodate the mounting pins could be easily replaced. However, Underdahl does not disclose the use of a spring-loaded pin assembly to allow repair of traditional shutters with either fixed or movable louvers. The prior art does not demonstrate using two spring-loaded pins to hold a fixed shutter louver. Configuring the housing of a shutter louver repair apparatus to fit into the grooves or slots of a traditional fixed louver shutter has also not been previously disclosed. While shutter louvers have been breaking for many years, spring-loaded pins have not previously been used to replacing louvers without disassembling the entire shutter.

### SUMMARY OF THE INVENTION

The present invention provides a Qwik Pin that can be used to replace a broken shutter louver without disassembling the shutter frame. Instead, the broken louver is removed, holes are drilled in each side of the shutter frame to accommodate the Qwik Pin, holes are drilled in the ends of a replacement louver as long as the width of the shutter, and the louver is installed by depressing the pins with a thin object or blade and allowing the pins to extend into the ends of the louver. Either fixed or movable louvers can be replaced with the Qwik Pin. For fixed louvers the replacement can be even simpler, by configuring the Qwik Pin housing to fit into the existing groove in the shutter frame, which held the end of the broken louver. Replacing a single louver requires two Qwik Pins, one for each end of the louver.

Two embodiments of the invention allow replacing either fixed louvers or movable louvers. A Qwik Pin with a single pin allows movement of the louvers. By providing two pins, the Qwik Pin will hold the louver in a fixed position. Louvers may be replaced without drilling holes in the shutter frame, if the dimensions of the Qwik Pin housing correspond to the dimensions of the louver being replaced.

The Qwik Pin allows replacement of the louvers of fixed and movable louver shutters with simple tools, minimal drilling, and without the hassle of disassembling the entire shutter to replace a single louver. Homeowners and crafts people will be able to replace broken louvers at the home or job site in a fraction of the time that was previously required.

These and various other advantages and features of novelty which characterize the invention are pointed out with clarity in the claims annexed hereto and forming a part hereof. However, for better understanding of the invention, its advantages, and the objects obtained by its use, reference should be made to the drawings which form a further part hereof, and to the accompanying descriptive matter, in which there is illustrated and described a preferred embodiment of the invention, including two configurations of the invention.

### BRIEF DESCRIPTION OF THE DRAWINGS

FIG. 1 shows a front prospective view of a shutter with louvers constructed according to the traditional method.

FIG. 2 shows a detailed, sectional view of the frame of a fixed louver shutter, with the ends of the louvers retained in grooves or slots in the side frame constructed according to the traditional method.

FIG. 3 shows a sectional view of the frame of a fixed louver shutter, with a louver removed, showing the groove or slot to hold the end of the louver.

FIG. 4 shows a detailed, sectional view of the frame of a movable louver shutter, with pins or dowels securing the louvers to the side frame constructed according to the traditional method.

FIG. 5 shows a sectional view of the frame of a movable louver shutter with a louver removed, showing the holes in the shutter frame and louver for the pin or dowel.

FIG. 6 shows a perspective view of the single-pin Qwik Pin.

FIG. 7 shows an exploded view of the single-pin Qwik Pin assembly including the housing, spring and pin.

FIG. 8 shows a sectional view of the single-pin Qwik Pin in the compressed position, in a shutter frame with a replacement louver.

FIG. 9 shows a section view of the single-pin Qwik Pin in the extended position, securing a replacement louver in a shutter frame, while allowing the rotation of the louver.

FIG. 10 shows a perspective view of the two-pin Qwik Pin.

FIG. 11 shows an exploded view of the two-pin Qwik Pin including the housing, spring and pin.

FIG. 12 shows a sectional view of the two-pin Qwik Pin in the compressed position, in a shutter frame with a replacement louver.

FIG. 13 shows a section view of the two-pin Qwik Pin in the extended position, securing a replacement louver in a shutter frame in a fixed position.

### DETAILED DESCRIPTION OF THE PREFERRED EMBODIMENTS OF THE INVENTION

The present invention provides a housing to be placed into the shutter frame, an interior housing or cap, a pin(s) which fit into the housing and which can be inserted into a hole(s) at the end of a shutter louver, and a spring which can be compressed and which upon decompressing extends the pin(s) into the hole(s) at the end of the shutter louver, to secure the replacement louver into the shutter frame. The Qwik Pin housing can be sized and shaped to correspond to the dimensions of a shutter louver, in which case the Qwik Pin can be mounted into the shutter frame without drilling or modifying the shutter frame. Alternatively, the Qwik Pin housing can be sized and shaped to be mounted into the shutter frame by drilling or otherwise creating a suitable hole or depression in the shutter frame. The Qwik Pin housing, interior housing or cap, spring and pin(s) can be manufactured from a variety of materials, including metals and plastics. In the preferred embodiment the housing, interior housing or cap, and pin(s) are made of plastic to avoid corrosion when the Qwik Pin is exposed to weather. The spring in the preferred embodiment is a metal coil spring.

The present invention could also be used in the original manufacturing and assembly of shutters and similar products to facilitate assembly and repair, by allowing installation of components between fixed elements without disassembly of the fixed elements. This invention could also be used with the housing installed in the louver or other interior component and the pins extending into the frame or fixed members, by configuring the Qwik Pin to fit those applications.

The present invention may also be used in other applications where replacement or installation of a component or object held between fixed members is desired, by installing the Qwik Pin into the fixed members and securing the components by extension of the spring-loaded pins.

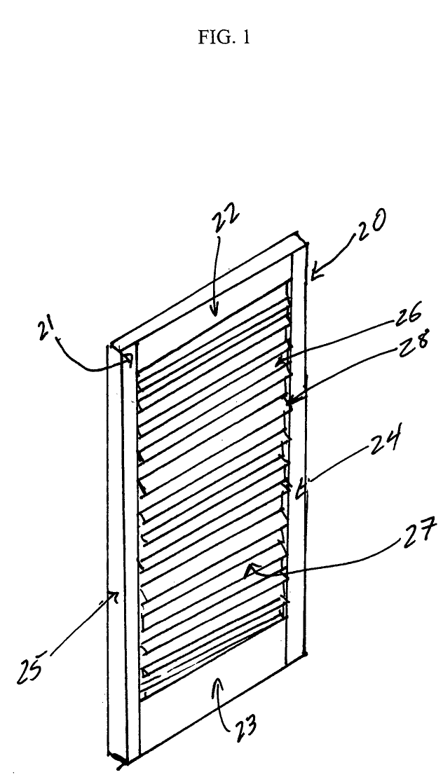

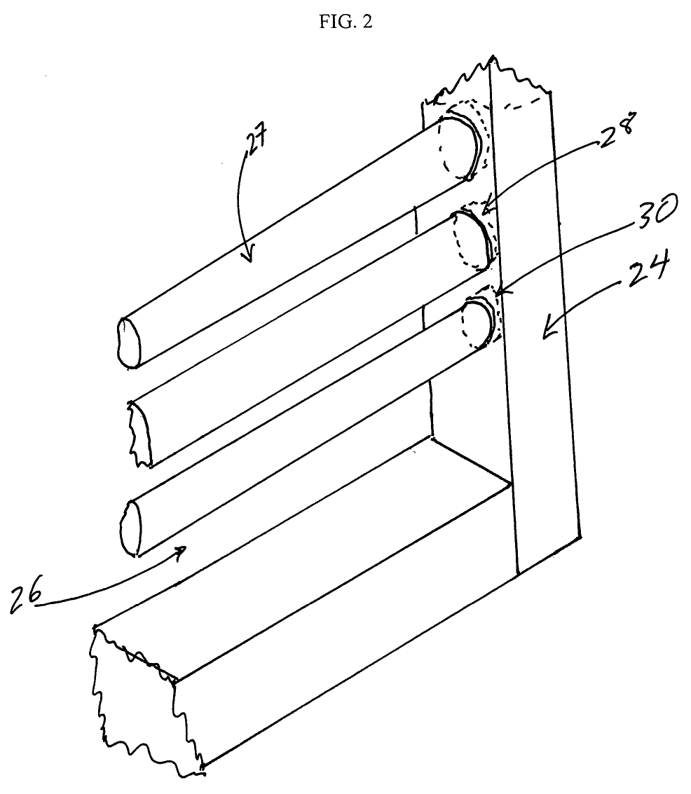

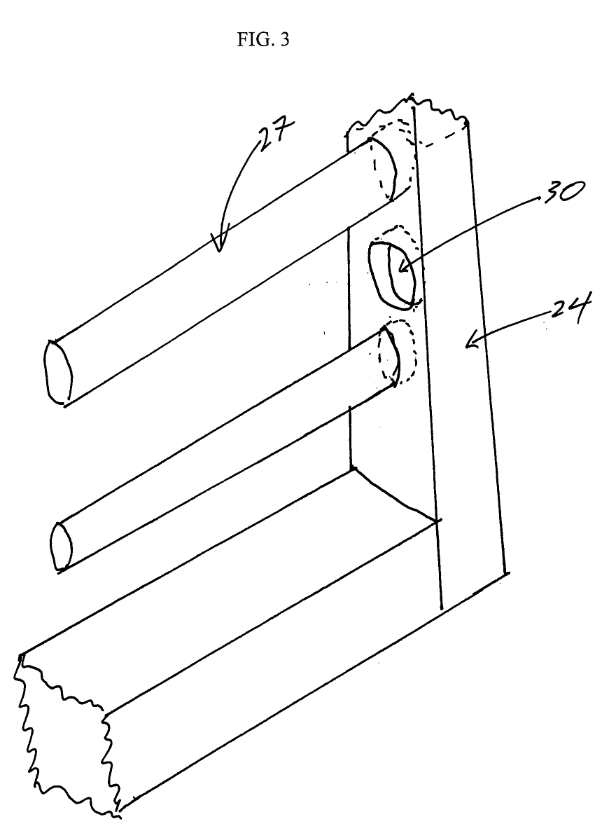

A Qwik Pin 10 (single pin configuration) and 50 (two pin configuration) constructed in accordance with the invention is depicted in the drawings. As shown in FIG. 1, a shutter constructed according to the traditional design 20 includes a rectangular frame 21 with a top part 22, bottom part 23, side frames 24 and 25, forming a frame opening 26, and a plurality of louvers 27. In the traditional construction of a fixed louver shutter, FIG. 2, the louvers 27 are each longer than the width of the frame opening 26 and have ends 28. The louvers 27 are secured by placing the ends 28 into grooves or slots 30 in the side frame 24. FIG. 3 depicts the grooves or slots 30 in the side frame 24 with a louver removed.

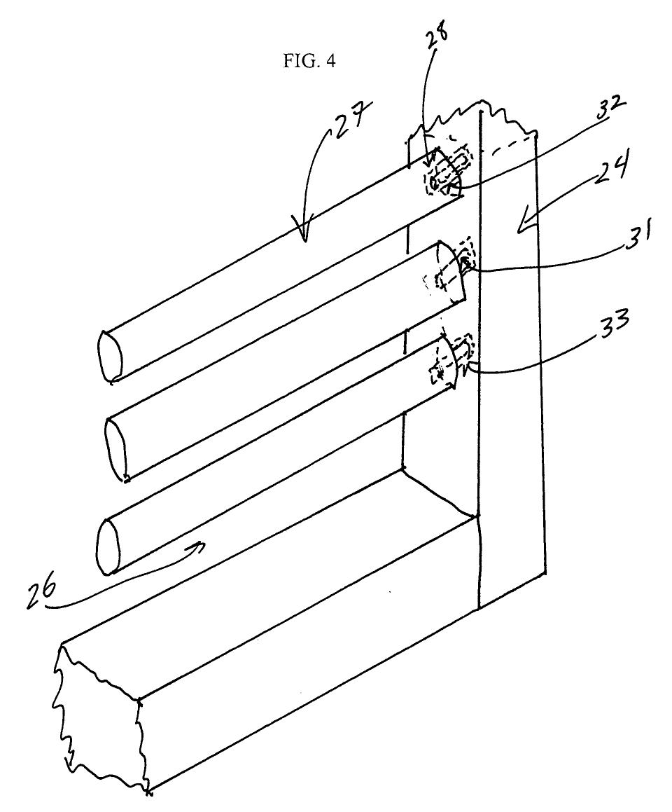

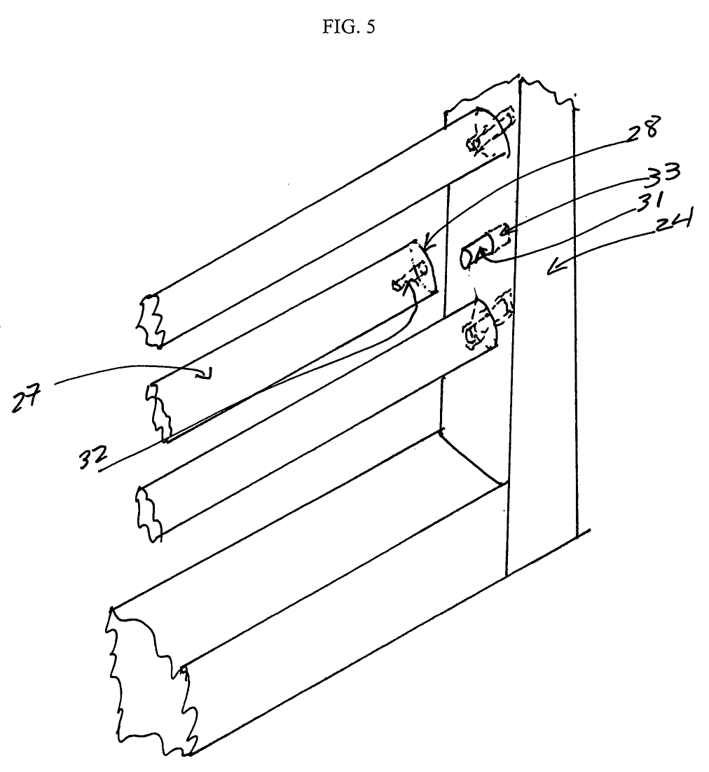

As shown in FIG. 4, the louvers 27 of a movable louver shutter constructed according to the traditional design are shorter than the width of the frame opening 26 and are secured by pins or dowels 31. The pins or dowels 31 are placed holes 32 in the end of each louver 28 and holes 33 in the side frame 24. The louvers 27 of a movable louver shutter can be moved around their longitudinal axises. FIG. 5 shows the holes 32 in the end of a louver 28 and the holes 33 in the side frame 24 with the louver 27 removed.

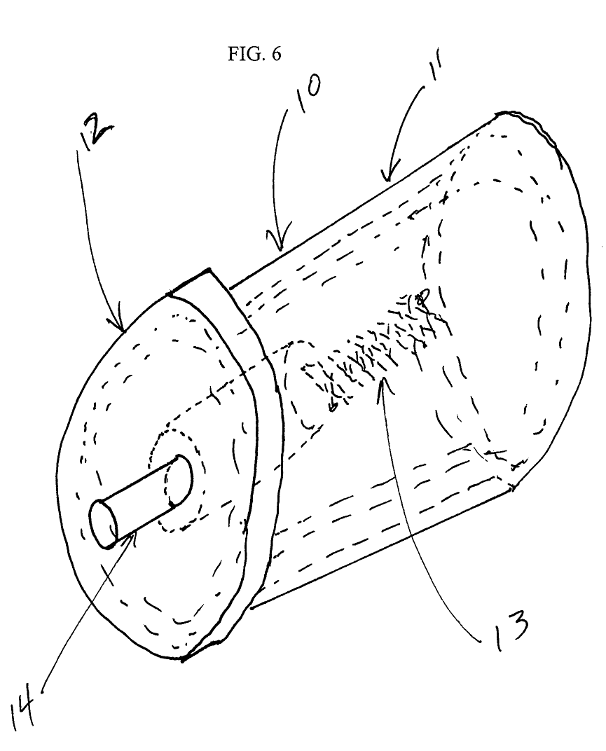

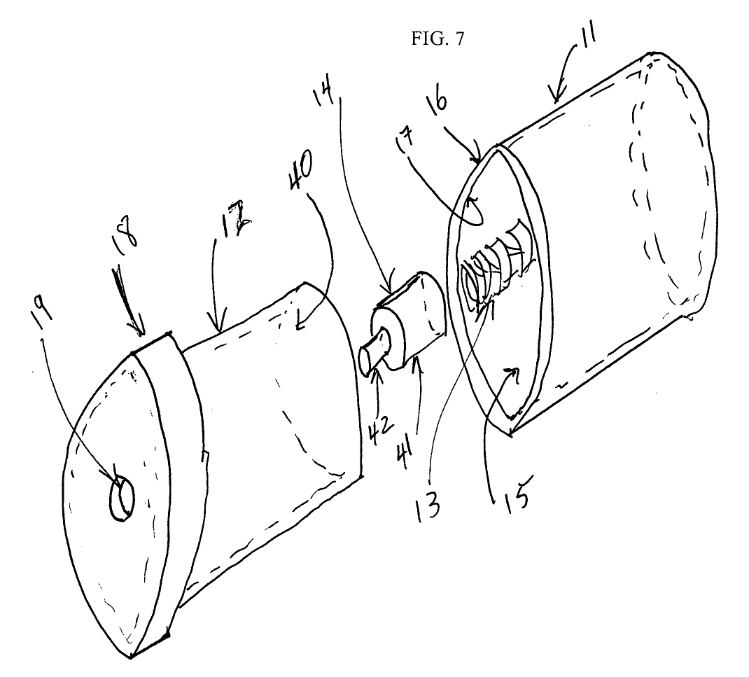

As shown in FIG. 6, the Qwik Pin 10 in the single pin configuration includes an outer housing 11, an inner housing 12, a spring 13 and a pin 14. The outer housing 11, an inner housing 12, spring 13 and pin 14 may be constructed of a variety of materials including metals and plastics. In the preferred embodiment of the single pin configuration as shown in FIG. 7, the outer housing 11 is cylindrical with an interior cavity 15, an outer dimension 16 and an inner dimension 17. The outer housing 11, alternatively, could be shaped to fit into the groove or slot 30 of a shutter frame 24. The inner housing 12 has a flange portion 18 which is larger than the outer dimension of the housing 16. The inner housing 12 has a hole 19 to accommodate the pin 14 and has an interior cavity 40. The pin 14 has a larger dimensioned portion 41 and a smaller dimensioned portion 42. The hole 19 is larger than the smaller dimensioned portion of the pin 41, but is smaller than the larger dimensioned portion of the pin 42. The larger dimensioned portion of the pin 41 fits within the interior cavity of the inner housing 40 and the smaller dimensioned portion of the pin 42 goes through the hole 19. The smaller dimensioned portion of the pin 42 is sized to fit into a hole in the end of a louver 28. The spring 13 is retained between the interior cavity of the outer housing 15 and the interior cavity of the inner housing 40 and is compressed by the pin 14.

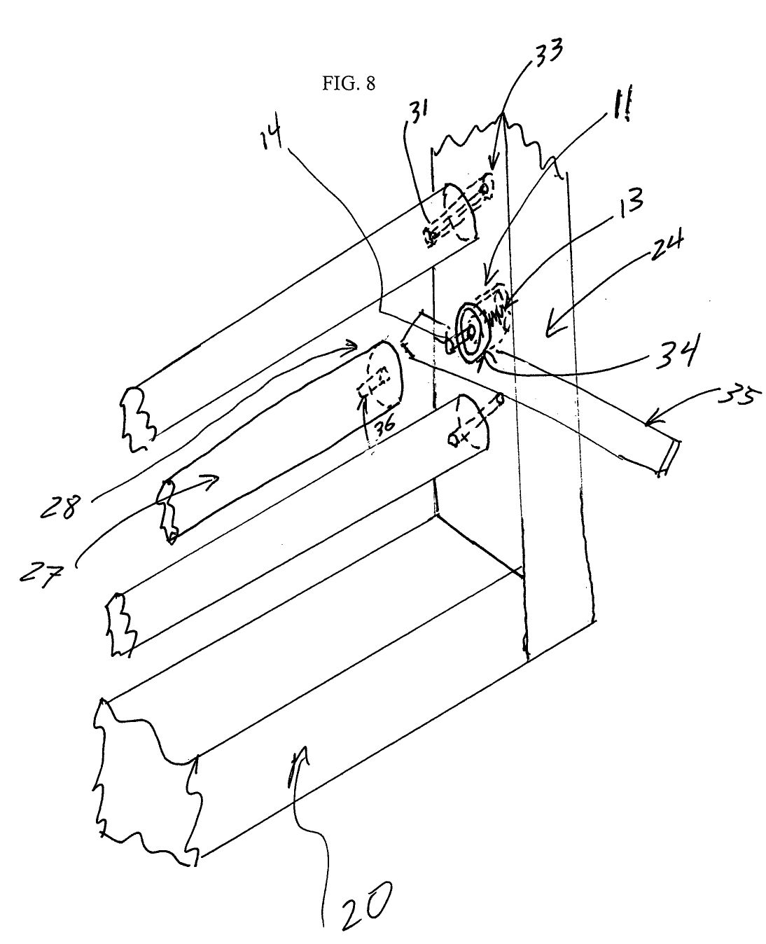

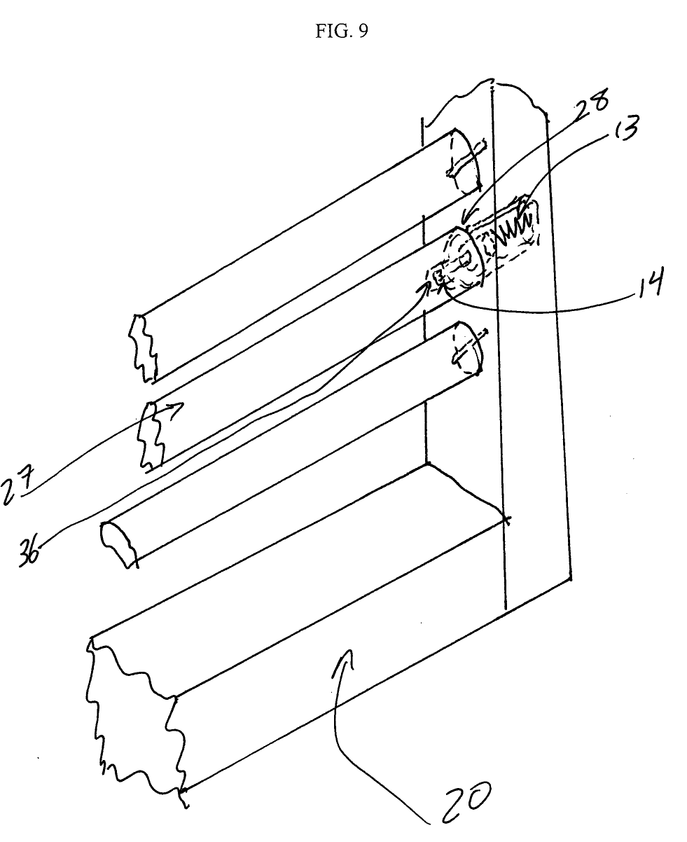

The use of the single-pin Qwik Pin to replace a movable louver is shown in FIGS. 8 and 9. As shown in FIG. 8, the single pin Qwik Pin is used by placing the outer housing 11 in an appropriately-sized hole 34 in the shutter's side frame 24 at the location of the hole 33 in the side frame 24, after removing the pin or dowel 31. When the spring 13 is compressed the pin 14 will be flush with the surface of the inner housing 12, allowing a replacement louver 27 to be installed in the shutter 20 using a thin object or blade 35 to depress the pin 14. By releasing pressure on the pin 14, the spring 13 will extend the pin 14 into a hole 36 which has been created in the end of the louver 28, securing the louver 27 in the shutter 20, along with another Qwik Pin securing the other end of the louver, as shown in FIG. 9. Since the louver is only secured by a single pin on each end the louver can be moved.

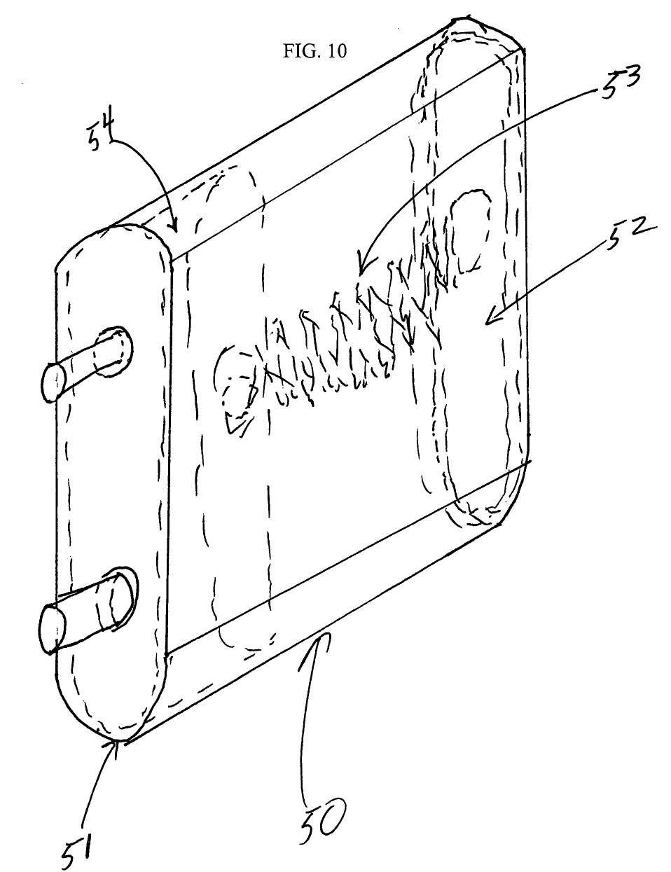

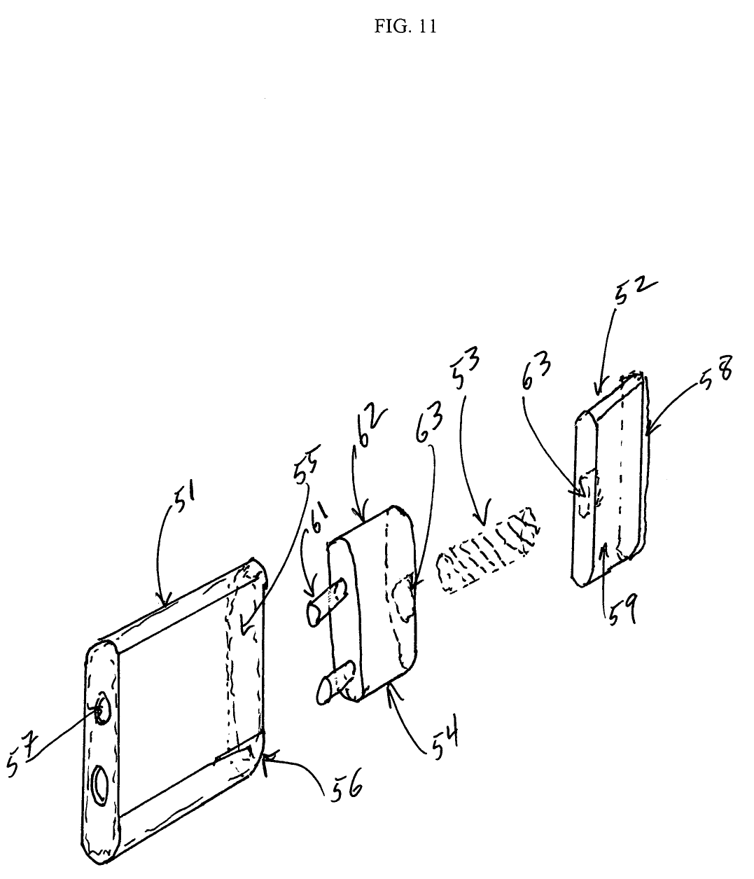

As shown in FIG. 10, the two pin configuration of the Qwik Pin 50 includes a housing 51, a cap 52, a spring 53 and a two-pin portion 54. The housing 51, the cap 52, spring 53 and two-pin portion 54 may be constructed of a variety of materials, including metals and plastics. In the preferred embodiment of the two-pin configuration as shown in FIG. 11, the housing 51 is shaped to fit into the groove or slot 30 in the shutter side frame 24. The housing 51 has an interior cavity 55, an interior dimension 56, and two holes 57. The cap 52 has a flange 58 that is larger than the interior dimension of the housing 56, a smaller portion 59 that is smaller than the interior dimension of the housing 56 and a cavity 60 to accommodate the spring 53. The two-pin portion 54 has two pins 61 which fit through the two holes 57, a larger portion 62 which fits inside the interior cavity of the housing 55 and a cavity 63 to accommodate the spring 53. The two pins 61 are sized to fit into holes in the end of a louver 28. The spring 53 is retained by the cavity of the cap 60 and the cavity of the two-pin portion 63 and is compressed by the two-pin portion 54.

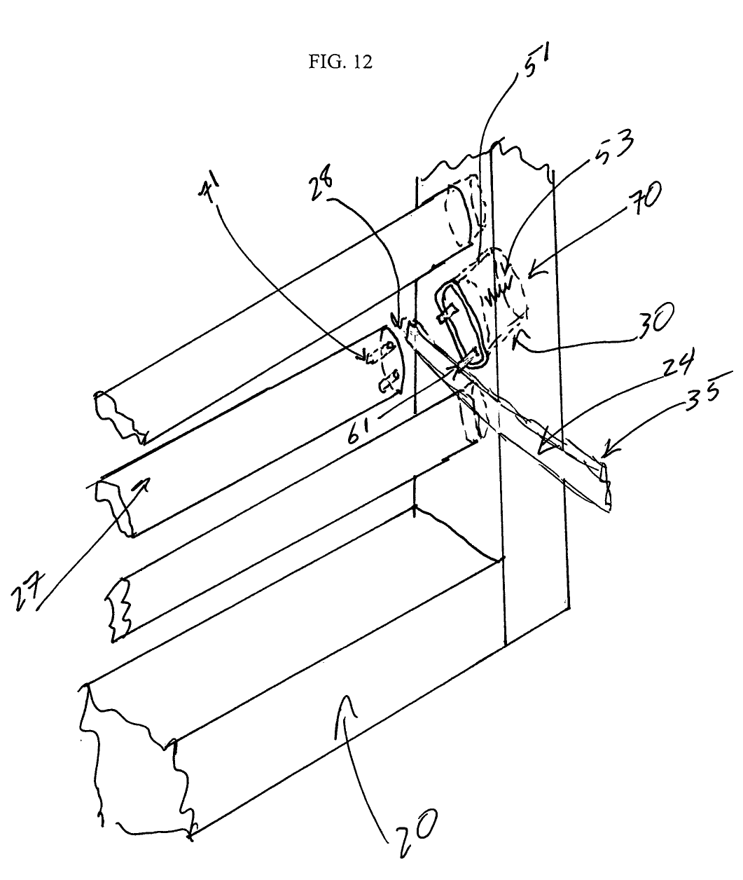

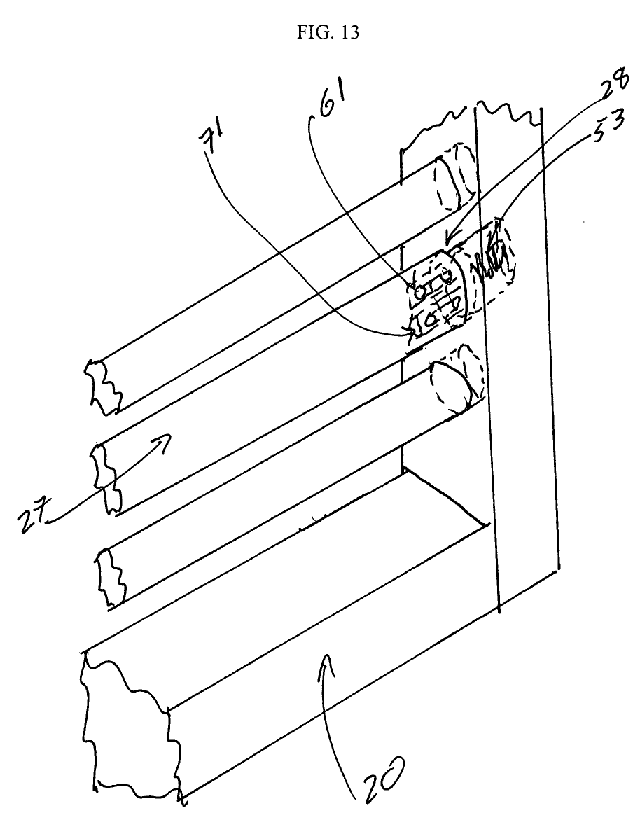

The use of the two-pin Qwik Pin to replace a fixed louver is shown in FIGS. 12 and 13. As shown in FIG. 12, the two-pin configuration is used by placing the housing 51 in the groove or slot 30 or in the an appropriately-sized hole 70 in the shutter's side frame 24. When the spring 53 is compressed the two pins 61 will be flush with the surface of the housing 51 allowing a replacement louver 27 to be installed in the shutter 20 using a thin object or blade 35 to depress the two pins 61. By releasing pressure on the two pins 61, the spring 53 will extend the two pins 61 into two holes 71 which have been created in the end of the louver 28, securing the louver 27 in the shutter 20, along with another Qwik Pin securing the other end of the louver, as shown in FIG. 13. Since the louver is secured by two pins at each end the louver is fixed and cannot be moved.

Though the foregoing detailed description of the present invention, it has been shown how the present invention has been achieved in a preferred manner. However, modifications such as those which readily occur to one skilled in the art are intended within the scope of the present invention.

What is claimed is:

1. A Qwik Pin, comprising:
a first housing with an interior cavity, an open end, a closed end, and a hole or holes through the closed end,
a pin or pins partially contained within said first housing and partially extending through said hole or holes configured such that only a portion of said pin or pins can fit through said holes,
a second housing which engages with the open end of said first housing, and
a spring placed intermediate to the portion of the pin or pins that is within said first housing and to the second housing and presses upon said pin or pins to extend said pin or pins through said hole or holes in the first housing.

2. A Qwik Pin, comprising:
a first housing with an interior cavity, an open end, a closed end, and two holes through the closed end,
a two pins partially contained within said first housing and partially extending through said holes configured such that only a portion of said pins can fit through said holes,
a second housing which engages with the open end of said first housing, and
a spring placed intermediate to the portion of the pin or pins that is within said first housing and to the second housing and presses upon said pins to extend said pins through said holes in the first housing, thereby allowing items to be fixedly secured.

3. A Qwik Pin for use in replacing shutter louvers, comprising:
a first housing with an interior cavity, an open end, a closed end, and a hole or holes through the closed end,
a pin or pins partially contained within said first housing and partially extending through said hole or holes configured such that only a portion of said pin or pins can fit through said holes,
a second housing which engages with the open end of said first housing, and
a spring placed intermediate to the portion of the pin or pins that is within said first housing and to the second housing and presses upon said pin or pins to extend said pin or pins through said hole or holes in the first housing.

4. A Qwik Pin for use in replacing shutter louvers, according to claim 3, wherein said first housing is shaped to fit into the groove or slot in a shutter frame provided to hold a shutter louver.

5. A Qwik Pin for use in replacing movable shutter louvers, comprising:
a first housing with an interior cavity, an open end, a closed end, and a hole through the closed end,
a pin partially contained within said first housing and partially extending through said hole configured such that only a portion of said pin can fit through said holes,
a second housing which engages with the open end of said first housing, and
a spring placed intermediate to the portion of the pin that is within said first housing and to the second housing and presses upon said pin to extend said pin through said hole in the first housing, thereby allowing a shutter louver to be moved.

6. A Qwik Pin for use in replacing movable shutter louvers, according to claim 5, wherein said first housing is shaped to fit into the groove or slot in a shutter frame provided to hold a shutter louver.

7. A Qwik Pin for use in replacing fixed shutter louvers, comprising:
a first housing with an interior cavity, an open end, a closed end, and two holes through the closed end,
a two pins partially contained within said first housing and partially extending through said holes configured such that only a portion of said pins can fit through said holes,
a second housing which engages with the open end of said first housing, and
a spring placed intermediate to the portion of the pins that is within said first housing and to the second housing and presses upon said pins to extend said pins through said holes in the first housing, thereby preventing a shutter louver from being moved.

8. A Qwik Pin for use in replacing fixed shutter louvers, according to claim 7, wherein said first housing is shaped to fit into the groove or slot in a shutter frame provided to hold a shutter louver.
